(19) United States
(12) Patent Application Publication
(10) Pub. No.: US 2013/0268481 A1
(43) Pub. Date: Oct. 10, 2013

(54) COMMUNICATION DEVICE AND METHOD FOR DISPLAYING NAME CARDS TO TERMINAL DEVICES

(71) Applicant: CHI MEI COMMUNICATION SYSTEMS, INC., New Taipei (TW)

(72) Inventors: YUN-JU CHEN, New Taipei (TW); BOR-CHUAN LIN, New Taipei (TW); PEI-HSI CHENG, New Taipei (TW)

(73) Assignee: CHI MEI COMMUNICATION SYSTEMS, INC., New Taipei (TW)

(21) Appl. No.: 13/778,142

(22) Filed: Feb. 27, 2013

(30) Foreign Application Priority Data
Apr. 9, 2012 (TW) 101112420

(51) Int. Cl. G06F 17/30

(52) U.S. Cl. CPC G06F 17/30345
USPC 707/609

(57) ABSTRACT

In a method for displaying a name card using communication device to one or more terminal devices, a personal database of a user of the communication device and a contact person group are established, and a name card corresponding to the contact person group is established. The method adds a contact person to the contact person group, and adds personal data to the name card. The communication device sends the name card to a cloud server through a wireless network, and the cloud server synchronously updates the name card to a terminal device of the contact person of the contact person group through the wireless network.

### BACKGROUND

1. Technical Field

The embodiments of the present disclosure relate to communication data management systems and methods, and more particularly to a communication device and method for displaying a name card to one or more terminal devices.

2. Description of Related Art

Because a user of a communication device may have different relations with different contact person, such as a classmate relation, a colleague relation, the user may want to share different name cards with different contact person when a communication connection is established between the communication device of the contact person and a terminal device of the user. Currently, there is no easy method to accomplish this task.

### BRIEF DESCRIPTION OF THE DRAWINGS

FIG. 1 is a block diagram of one embodiment of a communication device including a name card displaying system.

FIG. 2 is a block diagram of one embodiment of function modules of the name card displaying system in FIG. 1.

FIG. 3 is a flowchart of one embodiment of a method for displaying a name card.

FIG. 4 is one exemplary user interface including an edit area to edit personal data of a user of the communication device.

FIG. 5 is one exemplary user interface including a “person data add” button and a “contact person add button”.

FIG. 6 is one exemplary user interface of a name card which has been established.

FIG. 7 is one exemplary user interface including a “photo add” button.

FIG. 8 is one exemplary user interface including a “new contact person” button.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

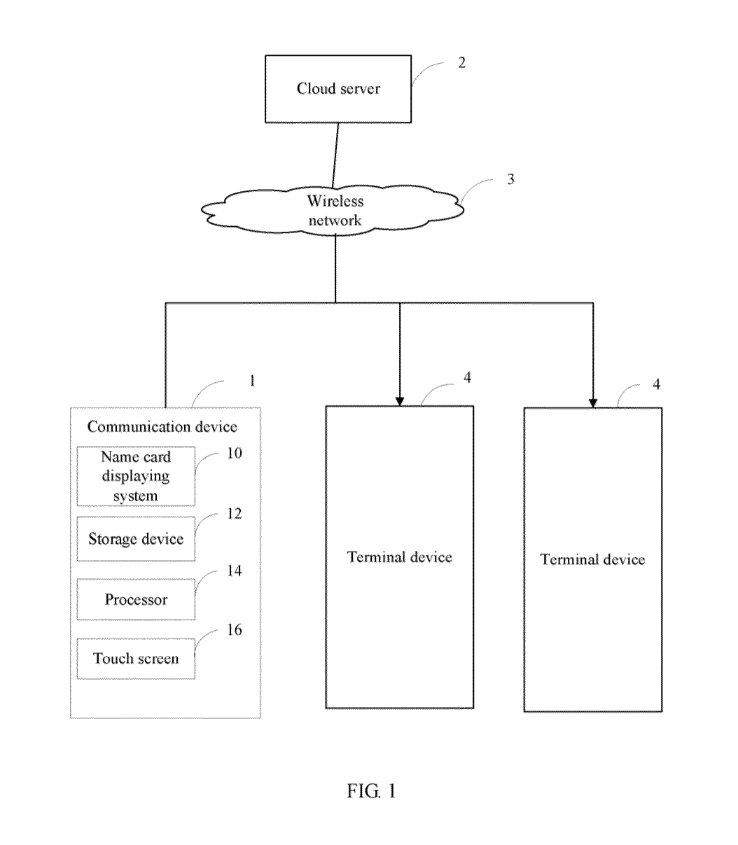

FIG. 1 is a block diagram of one embodiment of a communication device 1 including a name card displaying system 10. In the embodiment, the communication device 1 may further include a storage device 12, at least one processor 14, and a touch screen 16. The communication device 1 communicates with a plurality of terminal devices 4 through a wireless network 3, such as an WIFI network, a ZIGBEE network, or other wireless local area network (LAN). The communication device 1 and each of the terminal devices 4 connects to a cloud server 3 through the wireless network 3. The communication device 1 and each of the terminal devices 4 may be smart phones or tablets, etc.

The cloud server 2 synchronously updates a name card of a user of a communication device 1 to each of the terminal devices 4 through the wireless network 3. Each of the terminal devices 4 displays the name card when a communication connection is established between the communication device 1 and each of the terminal devices 4.

In one embodiment, the storage device 12 may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The touch screen 16 is an electronic visual display that receives a single-touch operation or a multi-touch operation when the touch screen 16 is touched with one or more fingers of the user.

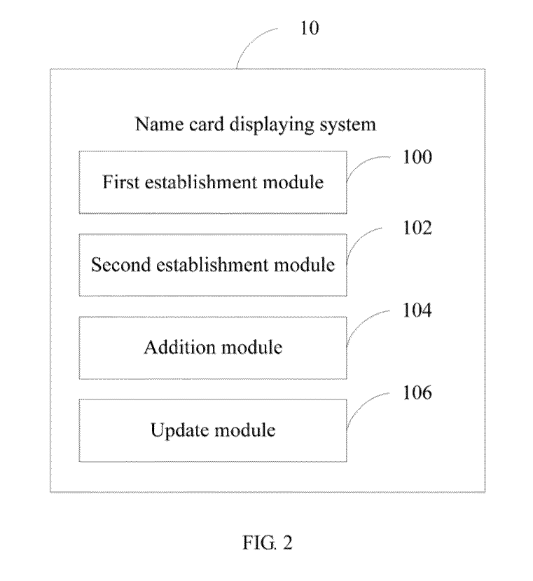

In one embodiment, the name card displaying system 10 includes a plurality of function modules (see FIG. 2 below), which include computerized codes or instructions that can be stored in the storage device 12 and executed by the at least one processor 14 to provide a method for displaying a name card.

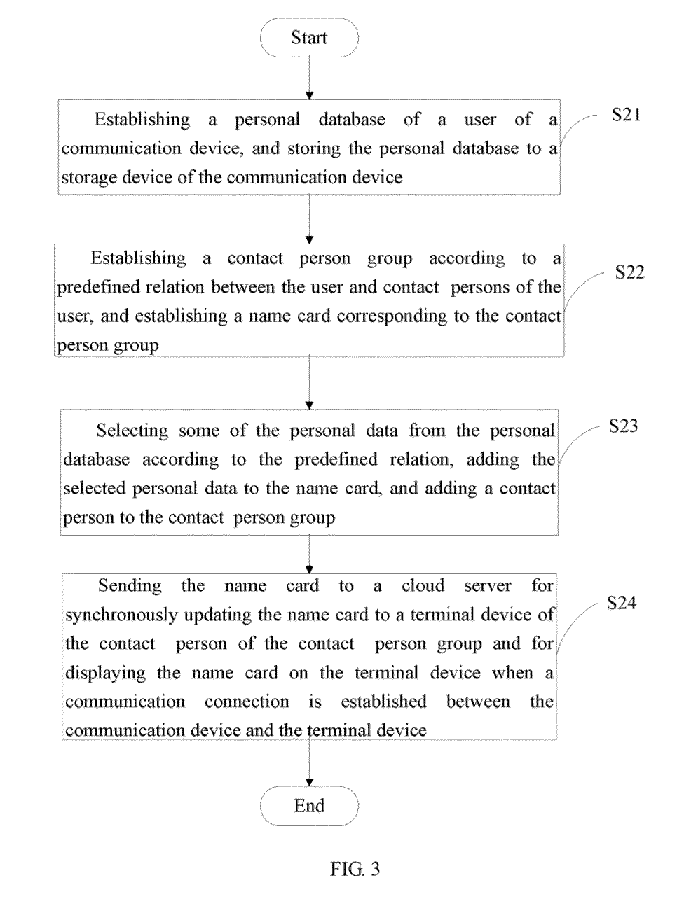

FIG. 2 is a block diagram of one embodiment of the name card displaying system 10 included in communication device 1. In one embodiment, the name card displaying system 10 may include a first establishment module 100, a second establishment module 102, an addition module 104 and an update module 106. The modules may comprise computerized codes in the form of one or more programs that are stored in the storage device 12 and executed by the at least one processor 14 to provide functions for implementing the modules. The functions of the function modules 100-106 are illustrated in FIG. 3 and described below.

FIG. 3 illustrates a flowchart of one embodiment of a method for displaying a name card using the communication device 1 to one or more terminal devices 4. Depending on the embodiment, additional steps may be added, others removed, and the ordering of the steps may be changed.

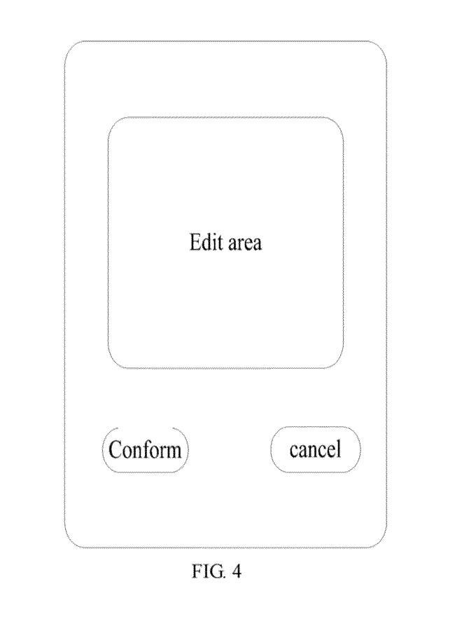

In block S21, the first establishment module 100 establishes a personal database for storing personal data of a user of the communication device 1, and stores the personal database in the storage device 12 of the communication device 1. The personal data of the user may include a name, a home address, a home telephone number, and an email of the user, for example. In one example with respect to FIG. 4, the first establishment module 100 may establish a first user interface, and display the first user interface on the touch screen 16. The first user interface may include a edit area, a “confirm” button and a “cancel” button displayed on the touch screen 16. The personal data of the user can be edited into the edit area by using the touch screen 16, thereafter the “confirm” button may be touched to confirm the editing of the personal data, or the “cancel” button may be touched to cancel the editing of the personal data.

In block S22, the second establishment module 102 establishes a contact person group according to a predefined relation between the user and contact person of the user, and establishes a name card corresponding to the contact person group. In the embodiment, the predefined relation may be a classmate relation, a family relation or a colleague relation, for example.

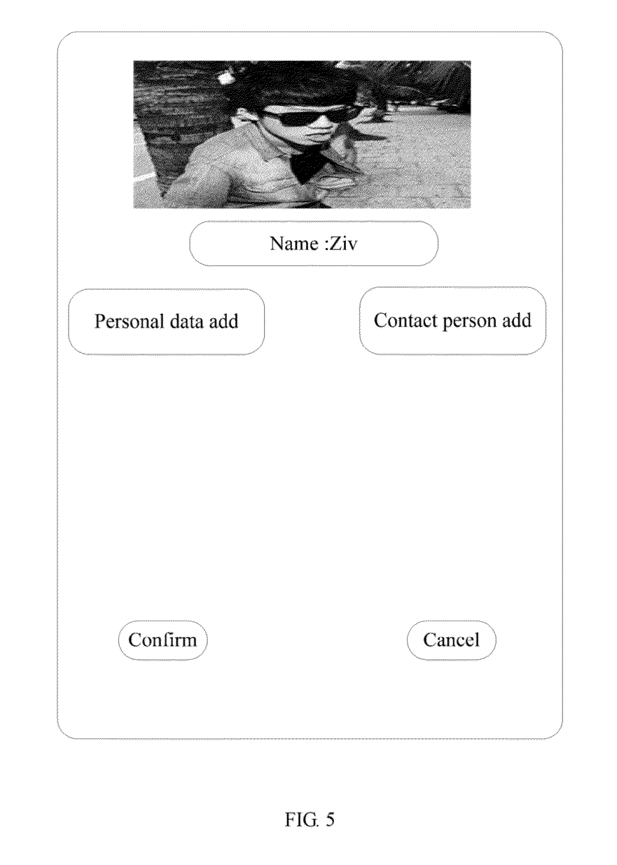

In block S23, the addition module 104 selects some of the personal data from the personal database according to the predefined relation, adds the selected personal data to the name card, and adds a contact person to the contact person group. In one example with respect to FIG. 5, the addition module 104 may establish a second user interface. The second user interface may include a “personal data add” button and a “contact person add” button. The personal data of the user may be added to the name card by touching the “personal data add” button, and the contact person stored in a phone book of the communication device 1 may be added to the contact person group by touching the “contact person add” button.

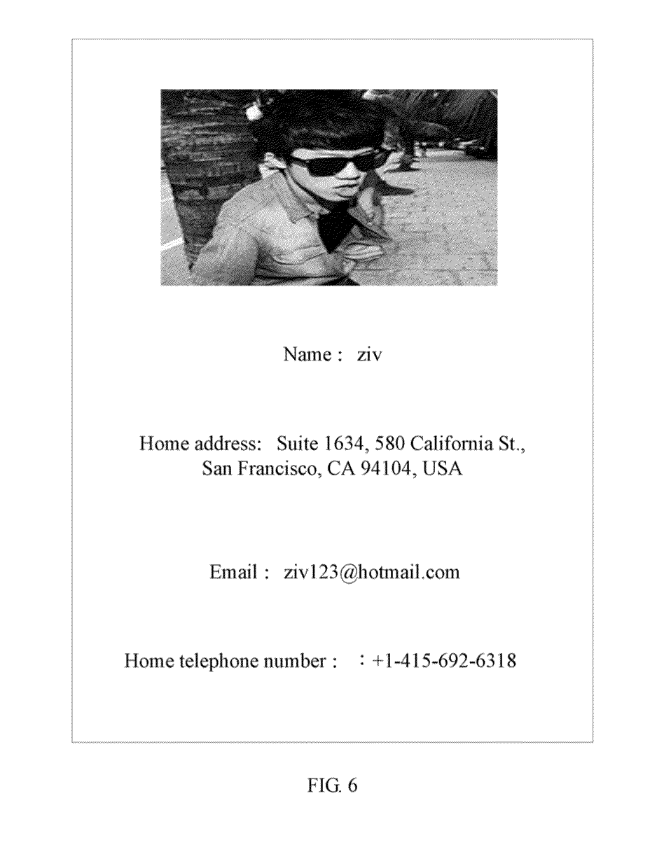

The FIG. 6 is an example of the name card which has been established. The name card may be established according to a classmate relation, and may include personal data of the user, such as a name, a home address, an email and a home telephone number of the user.

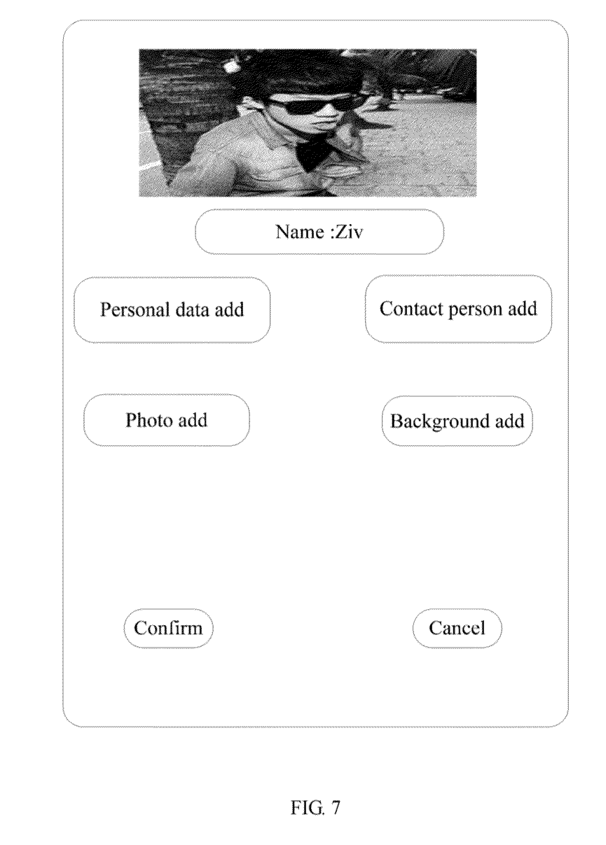

In one example with respect to FIG. 7, the second user interface may further include a “photo add” button and a “background add” button. A photo of the user stored in the storage device 12 of the communication device 1 may be added to the name card by touching the “photo add” button. And when the “background add” button is touched, pictures stored in the storage device 12 of the communication device 1 may be displayed on the second user interface, thereafter the user may add one of the pictures to be as a background of the name card.

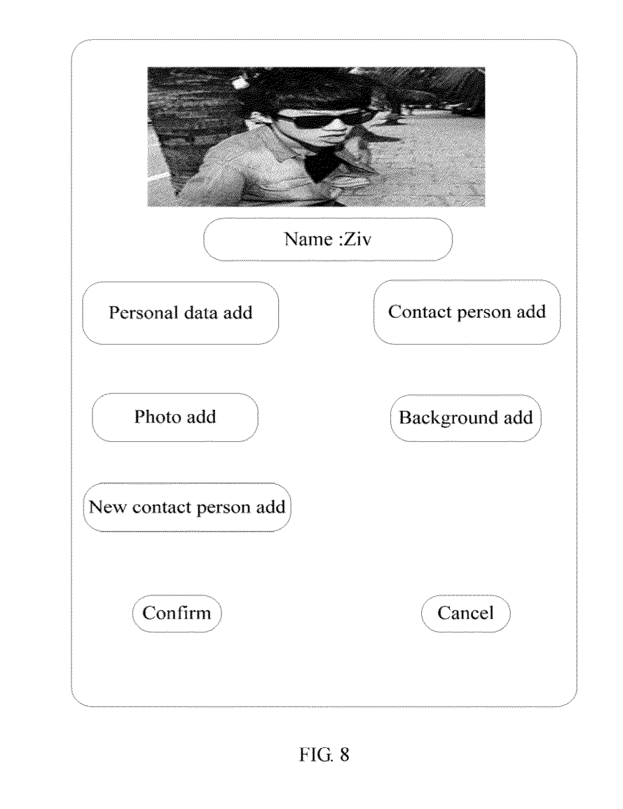

In another example with respect to FIG. 8, the second user interface may further include a “new contact person add” button. The “new contact person add” button may be touched to add a new contact person who is not stored in the phone book of the communication device 1 to the contact person group, including editing information of the new contact person. The information of the new contact person may be a name, a home address, an email address of the new contact person.

In block S24, the send module 106 sends the name card to the cloud server 2 through the wireless network 3, thereafter the cloud server 2 synchronously updates the name card to each of the terminal devices 4 of the contact person in the contact person group, to display the new name card on the each of the terminal devices 4 when a communication connection is established between each of the terminal devices 4 and the communication device 1.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device, comprising:
a storage device;
at least one processor;
a touch screen; and
one or more programs stored in the storage device comprising one or more programs and executed by the at least one processor, the one or more programs comprising:
a first establishment module that establishes a personal database for storing personal data of a user of the communication device, and stores the personal database in the storage device;
a second establishment module that establishes a contact person group according to a predefined relation between the user and contact persons of the user, and establishes a name card corresponding to the contact person group;
an addition module that selects a plurality of personal data from the personal database according to the predefined relation, and adds the selected personal data to the name card, and adds a contact person to the contact person group; and
an update module that sends the name card to a cloud server for synchronously updating the name card to a terminal device of the contact person of the contact person group and for displaying the name card on the terminal device when a communication connection is established between the communication device and the terminal device.

2. The communication device according to claim 1, wherein the personal data of the user comprises a name, a home address, a home telephone number, and an email of the user.

3. The communication device according to claim 1, wherein the addition module further adds pictures stored in the storage device to be a background of the name card.

4. The communication device according to claim 1, wherein the information of the contact person added to the contact person group is stored in a phone book of the communication device.

5. The communication device according to claim 1, wherein the predefined relation is a classmate relation, a family relation or a colleague relation.

6. A method for displaying a name card to one or more terminal devices using a communication device, the method comprising:
establishing a personal database of a user of the communication device, and storing the personal database to a storage device of the communication device;
establishing a contact person group according to a predefined relation between the user and contact persons of the user, and establishing a name card corresponding to the contact person group;
selecting a plurality of the personal data from the personal database according to the predefined relation, adding the selected personal data to the name card, and adding a contact person to the contact person group;
sending the name card to a cloud server for synchronously updating the name card to a terminal device of the contact person of the contact person group and for displaying the name card on the terminal device when a communication connection is established between the communication device and the terminal device.

7. The method according to claim 6, wherein the personal data of the user comprises a name, a home address, a home telephone number and an email of the user.

8. The method according to claim 6, further comprising:
adding pictures stored in a storage device of the communication device to be a background of the name card.

9. The method according to claim 6, wherein the information of the contact person added to the contact person group is stored in a phone book of the communication device.

10. The method according to claim 6, wherein the predefined relation is a classmate relation, a family relation or a colleague relation.

11. A non-transitory computer-readable storage medium having stored thereon instructions being executed by a processor of a communication device, causes the communication device to perform a method for displaying a name card to one or more terminal devices, the method comprising:
establishing a personal database of a user of the communication device, and storing the personal database to a storage device of the communication device;
establishing a contact person group according to a predefined relation between the user and contact persons of the user, and establishing a name card corresponding to the contact person group;
selecting a plurality of the personal data from the personal database according to the predefined relation, adding the selected personal data to the name card, and adding a contact person to the contact person group;
sending the name card to a cloud server for synchronously updating the name card to a terminal device of the contact person of the contact person group and for displaying the name card on the terminal device when a communication connection is established between the communication device and the terminal device.

12. The storage medium according to claim 11, wherein the personal data of the user comprises a name, a home address, a home telephone number and an email of the user.

13. The storage medium according to claim 11, wherein the method further comprising:
adding pictures stored in a storage device of the communication device to be a background of the name card.

14. The storage medium according to claim 11, wherein the information of the contact person added to the contact person group is stored in a phone book of the communication device.

15. The storage medium according to claim 11, wherein the predefined relation is a classmate relation, a family relation or a colleague relation.
